(19) United States
(12) Patent Application Publication
(10) Pub. No.: US 2013/0275602 A1
(43) Pub. Date: Oct. 17, 2013

(54) Hop-By-Hop Bandwidth Consumption Measurements Control Cooperation Between Clients on a Data Network

(71) Applicants: Anton Havekes, Schiedam (NL); Victor Klos, The Hague (NL); Peter-Jan Doets, Delft (NL); Hans Maarten Stokking, Wateringen (NL); Martin Prins, The Hague (NL)

(72) Inventors: Anton Havekes, Schiedam (NL); Victor Klos, The Hague (NL); Peter-Jan Doets, Delft (NL); Hans Maarten Stokking, Wateringen (NL); Martin Prins, The Hague (NL)

(73) Assignee: KONINKLIJKE KPN N.V., The Hague (NL)

(21) Appl. No.: 13/995,835

(22) PCT Filed: Dec. 21, 2011
(86) PCT No.: PCT/EP2011/073528

§ 371 Date: Jun. 19, 2013

(30) Foreign Application Priority Data
Dec. 23, 2010 (EP) 10196686.9

(51) Int. Cl. H04L 12/70

(52) U.S. Cl. CPC H04L 47/70
USPC 709/226

(57) ABSTRACT

A bandwidth consumption conflict may arise on a bottleneck data link in a data network, when a specific data processing system intends to use the bottleneck data link for a new data communication session. The conflict is resolved through negotiations with the other data processing systems that are currently consuming bandwidth on the bottleneck data links and/or with one or more other entities representing these other data processing systems at the negotiations. The negotiations may be initiated and conducted by the specific data processing system, or by another entity that is acting on behalf of the specific data processing system. The bottleneck data links may be determined by the specific data processing system itself or by yet another entity. The other data processing systems are identified by the specific data processing system itself or by still another entity. Eventually, the specific data processing system or its representative at the negotiations conducts the negotiations under control of the information, received from one or more other entities or determined otherwise, about the identity of the bottleneck data links and about the identity of the other data processing systems.

### FIELD OF THE INVENTION

The invention relates to a method of managing bandwidth consumption of a community of data processing systems connected to a data network. The invention further relates to a data processing system, and to control software on a computer-readable medium.

### BACKGROUND ART

A data network enables a plurality of data communication systems to communicate data with each other via the data network. Examples of such a data network that serves a community of data processing systems are a local-area network (LAN) serving a community (e.g., a residence, an office, a building, or a geographically limited service or business infrastructure) and a wide-area network (WAN) such as the Internet. Examples of data communication systems are consumer electronics systems configured for processing electronic content information received via the data network: a personal computer with a data network interface, a home entertainment network, an Internet TV, mobile personal devices such as a smartphone or a mobile media player with an interface to a wireless network, a TV that is configured for digital video broadcast (DVB), etc. Other examples are devices or systems configured as a data resource for supplying such electronic content information via the data network: video servers or audio servers on the Internet, a personal computer with a data network interface, a smartphone, etc. Still another example of a data network forming a community of data processing systems is a network of sensors monitoring an environment, e.g., sensor networks for condition monitoring of an industrial plant, a wind turbine park, etc., and communicating sensor data to a central monitoring station.

A data network is typically formed by means of interconnecting multiple network nodes (e.g., routers, repeaters, switches, gateways, access nodes) via one or more data links, thus providing a one or more data paths in the logical topology of the network between any pair of network nodes.

The protocols that specify the way, wherein data communication via a data network is to be brought about, require that the data be communicated in pre-formatted data packets. Each of the data packets has a source identifier for identifying the source of the data, e.g., a first network address, and a destination identifier that identifies the destination of the data, e.g., a second network address. A data link interconnecting a pair of network nodes can thus be used in a multiplexed manner for the communication of data from different sources connected to the data network to different destinations on the data network. The source identifiers of the data packets and the destination identifiers of the data packets enable the network nodes to discriminate between the data packets so as to be able to selectively forward the data packets to the proper next ones of the network nodes on the data paths towards the different destinations.

Any data link interconnecting a pair of network nodes has a limited communication capacity or bandwidth, expressed in, e.g., a specific number of megabits per second this data link is able to support. Therefore, the data network itself manages bandwidth by means of controlling the number of data packets per data link, in order to avoid overfilling the data link. Overfilling a data link leads to network congestion and poor network performance.

Reference is made to the publication “Locating Internet Bottlenecks: Algorithms, Measurements, and Implications”, Ningning Hu et al., SIGCOMM '04, Aug. 30-Sep. 3, 2004, Portland, Oreg. The authors address the problem of locating network bottlenecks in IP (Internet Protocol) data networks. A network bottleneck is a specific data link between a pair of network nodes that is currently affecting the performance or the capacity of the entire data network because of the data traffic via this specific data link is close to, or has reached, the limit of its bandwidth.

The following is quoted from above publication. The ability to locate network bottlenecks along end-to-end paths on the Internet is of great interest to both network operators and researchers. For example, knowing where bottleneck links are, network operators can apply traffic engineering either at the inter-domain or intra-domain level to improve routing. The authors present an active single-end probing tool that allows end users to efficiently and accurately locate the bottleneck link on an Internet path. The tool presented is based on a probing technique called Recursive Packet Train (RPT) and does not require access to the destination. The tool is evaluated using wide-area Internet experiments and trace-driven emulation. In addition, the authors present the results of an extensive study on bottlenecks in the Internet using carefully selected, geographically diverse probing sources and destinations. The authors have found that the tool can successfully detect bottlenecks for almost 80% of the Internet paths probed. The authors also report successes in using the bottleneck location and bandwidth bounds provided by the tool to infer bottlenecks and to avoid bottlenecks in multi-homing and overlay routing.

Other tools for measuring hop-by-hop performance in a data network are known from, e.g., A. Akella, S. Seshan, and A. Shaikh, “An empirical evaluation of wide-area internet bottlenecks”, Proc. ACM IMC, October 2003; and V. Jacobson, “Pathchar—a tool to infer characteristics of internet paths”, 1997, Presented as April 97 MSRI talk.

Accordingly, methods are known to identify network bottlenecks on a hop-by-hop basis, i.e., on the basis of individual data links that interconnect the nodes forming a data network.

### SUMMARY OF THE INVENTION

Accordingly, tools are known to enable, e.g., end-user data processing systems to identify network bottlenecks on a hop-by-hop basis, i.e., on the basis of individual data links.

The inventors now propose to use such a tool in order to obtain information about a data link in a data network that is possibly going to be a network bottleneck for a community of end-user data communication systems if an additional data communication session is going to be initiated, and to enable the community of these end-user data communication systems to manage itself so as to have the end-user data processing systems individually adjust their respective bandwidth requirements under control of an optimization algorithm.

More specifically, the invention relates to a method of managing bandwidth consumption of a community of data processing systems connected to a data network. The data network comprises a plurality of nodes interconnected through data links. The method comprises determining an additional amount of bandwidth required for a specific data communication session of a specific one of the data processing systems with a resource on the data network, before the specific data communication session is initiated; and determining if the additional amount of bandwidth causes a conflict with current bandwidth consumption on at least a specific one of data links. If the additional amount of bandwidth causes a conflict with the current bandwidth consumption, the method comprises identifying one or more other ones of the data processing systems currently involved in the bandwidth consumption on the specific data link; and initiating resolving the conflict by means of negotiating with the one or more other data processing systems a respective reduction in a respective other amount of bandwidth currently consumed by a respective one of the other data processing systems.

As mentioned above, tools are known to enable to determine network performance on a hop-by-hop basis along the end-to-end path through the data network, e.g., from an end-user data processing system to an electronic content server. That is, the performance is determined per individual data link of an end-to-end path connecting the end-user data processing system to the electronic content server. Consider now, a specific data processing system of an end-user, who intends to initiate a data communication session with a specific content server, e.g., for downloading a data file, or for having a data file streamed, from the server to the specific data processing system via the data network. The downloading or the streaming needs a certain bandwidth. For example, the streaming of a media file from the server to the data processing system of the end-user needs a certain minimum bit-rate in order to enable uninterrupted play-out at the data processing system. As another example, the bit-rate for downloading a data file from the server to the data processing system of the end-user via the data network may also be critical if the end-user intends to use (browse, play-out, interact with) the data file upon completion of the download or even during the download. If the end-user has to wait too long, the end-user will probably abort the download-session and perhaps try another source. Information about the amount of bandwidth, required for the session of the specific data processing system is, for example, communicated by the electronic content server to e.g., the specific data processing system, or is known in advance, e.g., from an electronic program guide (EPG). In the invention, a tool of the kind specified above, is used to determine if the amount of bandwidth, required for the downloading or for the streaming, will cause a conflict with current bandwidth usage by one or more other data processing systems of the community at at least a specific data link. The tool enables to acquire information about the data links in the end-to-end path between the specific data processing system and the specific content server. The information comprises, e.g., the magnitude of the total bandwidth supported per individual data link and the magnitude of the currently available bandwidth per individual data link. Note that the total bandwidth supported by an individual data link and the available bandwidth per individual data link are relevant parameters for determining a possible bandwidth conflict on that individual data link if the data communication session between the specific data processing system and the specific content server is going to be initiated.

After the one or more specific data links have been determined that will give rise to a bandwidth conflict if the session is going to be initiated, other ones in the community of data processing systems are identified that are currently consuming bandwidth on the one or more specific data links. Once the other data processing systems have been identified, bandwidth usage on the specific data link may be adjusted per individual one of the other data processing systems so as to free up bandwidth for the intended session of the specific data processing system. The adjustment of the bandwidth is a viable solution if, for instance, the bit-rate of the ongoing sessions involving the other data processing systems, can indeed be reduced without seriously affecting the ongoing sessions. For example, the bit-rate of a download session could be reduced so that it will take some longer time for the download to complete. As another example, the bit-rate of a streaming session could be reduced by changing to another coding scheme. Within this context, reference is made to scalable coding schemes for audio and video, such as multi-bitrate encoding schemes known in the art. For example, Scalable Video Coding (SVC) is an extension to the H.264/MPEG-4 AVC video compression standard, and allows a graceful degradation of the perceived quality of the video played out if bandwidth is decreased. Further examples of multi-bitrate coding are discussed further below.

Several entities on the data network can be configured to carry out the process of determining the one of more data links that will create a bandwidth conflict if the new data communication session of the specific data processing system starts. For example, the specific data processing system itself can be configured to use the tool for determining bandwidth bottlenecks on a the hop-by-hop basis. As another example, the electronic content server, which receives the request from the specific data processing system for the new data communication session, is configured to determine the bottlenecks on the end-to-end path. As yet another example, a network node between the specific data processing system of the end-user and the electronic content server is configured for identifying the bandwidth bottlenecks: e.g., a router, a gateway of the community or a home gateway of the end-user.

There are several ways to identify the other ones in the community of the data processing systems that are currently using the bottleneck data links. For example, if the specific data processing system itself has carried out the process of determining the bottleneck data links, the specific data processing system may broadcast to the community a message with a request to any of the other data processing systems to respond to the specific data processing system, if they are currently using the one or more bottleneck links. The message may be broadcast over the same data network or via another connection with the data processing systems. As another example, if the entity, which has identified the bottleneck data links, is different from the specific data processing system, the entity may inform the specific data processing system of the bottleneck data links. The specific data processing system may then broadcast to the community the message with the request to any of the other data processing systems to respond if they are using the one or more bottleneck data links. The message is broadcast via the data network or via another connection. As yet another example, if the entity, which has identified the bottleneck data links, is different from the specific data processing system, this entity may broadcast to the community the message with the request to any of the other data processing systems to respond to the entity itself or to the specific data processing system, if they are using the one or more bottleneck links. As yet another example, all data processing systems of the community register with a community server or at the community gateway to inform the community server of the data links they are currently using. As yet another example, all data processing systems of the community keep each other informed about the data links they are currently using.

Accordingly, there are a variety of manners wherein the bottleneck data links can be identified and a variety of ways wherein the other data processing systems of the community can be identified that are currently using the bottleneck data links, e.g., via regular broadcasts via the data network or via another connection.

The information about the other data processing systems that are currently using the one or more bottleneck data links is used by the specific data processing system, or by another entity acting on behalf of the specific data processing system, to contact these other data processing systems, or entities acting on behalf of them, in order to start negotiating with the other data processing systems and/or these entities, about relinquishing some of the currently consumed bandwidth.

The specific data processing system may itself carry out the negotiating. Alternatively, another entity may carry out the negotiations on behalf of the specific data processing system. As to carrying out the negotiations on behalf of the specific data processing system, the data processing system may, for example, delegate the functionality of negotiating to another entity acting on behalf of the specific data processing system for the purpose of the negotiations. For example, the specific data processing system delegates the negotiating to a community server on the community of data processing systems or to another dedicated data processing entity of the end-user of the specific data processing system. That is, the specific data processing system requests the community server or the other dedicated data processing entity to start negotiating on behalf of the specific data processing system. The community server or the dedicated data processing entity runs a software agent representing the interests of the specific data processing system during the negotiations. The community server or the dedicated data processing entity may run such software agents for multiple ones of the data processing systems in the community. The negotiations between the specific data processing system and the other data processing systems are then carried out by the software agent of the specific data processing system and the other software agents of the other data processing systems. Alternatively, another entity may actively intercede in order to negotiate on behalf of the specific data processing system on the basis of monitoring the network traffic generated by the specific data processing system. The other entity may then assume, on its own accord, the role of the specific data processing system for the purpose of the conducting negotiations. Alternatively, the specific data processing system interacts via a proxy with the other data processing systems of the community. The proxy then represents the specific data processing system with respect to the community for the purpose of conducting negotiations.

Summarizing, a method of the invention as specified above, seeks to resolve a bandwidth conflict on one or more bottlenecks data links in a data network that may arise when a specific data processing system intends to use the one or more bottleneck links for a new data communication session. The conflict is resolved on the basis of negotiations with other data processing systems that are currently consuming bandwidth on the bottleneck data links and/or with one or more data processing entities representing these other data processing systems. The negotiations may be initiated and conducted by the specific data processing system, or by another entity that is acting on behalf of the specific data processing system. The bottleneck data links may be determined by the specific data processing system itself or by another entity. The other data processing systems, which are consuming bandwidth on the bottleneck data links, are identified by the specific data processing system or still another entity. Eventually, the specific data processing system or its representative at the negotiations conducts the negotiations under control of the information, received from another entity or otherwise determined, about the identity of the bottleneck data links, and about the identity of the other data processing systems.

The process of negotiating about adjusting per data link the individual bandwidth for one or more individual ongoing sessions in order to free up bandwidth for a new session can be implemented in a variety of manners.

For example, consider that the specific data processing system has identified the specific data link that is going to be a bottleneck. As mentioned earlier, the identification may have been carried out by the specific data processing system itself. As the specific data processing system participates in a community of data processing systems, the specific data processing broadcasts to the community a request to have the other data processing systems identify themselves with respect to the specific data processing system if these other data processing systems are involved in data communication sessions that use the specific data link. Once the other data processing systems have identified themselves, the specific data processing system and the other data processing systems initiate an interaction to resolve the conflict by means of having one or more of the other data processing systems giving up some bandwidth. For example, the specific data processing system and the other data processing systems start negotiations in order to have one or more of the other data processing systems reduce their bandwidth for the data communication sessions that use the specific data link. Negotiations may be based on, e.g., game theory see, e.g., “Coalitional Game Theory for Communication Networks: A Tutorial”, Walid Saad et al., IEEE Signal Processing Magazine, Special Issue on Game Theory, vol. 26, no. 5, pp. 77-97, September 2009; and “Game theory in wireless networks: a tutorial”, M. Felegyhazi et al., in: EPFL technical report, LCA-REPORT-2006-002 (February 2006). Alternatively, each respective one of the data processing systems of the community has a respective rule base with pre-determined rules that specify under what conditions the respective data processing system is to relinquish some bandwidth and, depending on the circumstances, how much.

As another example, consider that the specific content server has identified the specific data link that is going to be a bottleneck in the end-to-end path of the specific data processing system. The specific content server can also determine the identity of the other data processing systems that are currently communicating with the content server via the specific data link. Accordingly, the content server can notify the specific data processing system of the other data processing systems with which the specific data processing system is to negotiate about freeing up bandwidth at the specific data link, using, e.g., game theory. Alternatively, the specific data processing system and the other data processing systems are each equipped with pre-defined rule bases that specify how to automatically have the bandwidth usage re-adjusted according to pre-determined criterions. If the router notifies the other data processing systems of the shortage of bandwidth on the specific link, the other data processing systems automatically apply their rule base and decrease their bandwidth usage.

As another example, consider that the router has identified the specific data link that is going to be a bottleneck in the end-to-end path of the specific data processing system. The router can also determine the identity of the other data processing systems that are currently communicating with via the router and via the specific data link. Accordingly, the router can notify the specific data processing system of the other data processing systems with which the specific data processing system is to negotiate about freeing up bandwidth at the specific data link, using, e.g., game theory. Alternatively, the specific data processing system and the other data processing systems are each equipped with pre-defined rule bases that specify how to automatically have the bandwidth usage re-adjusted according to pre-determined criterions. If the router notifies the other data processing systems of the shortage of bandwidth on the specific link, the other data processing systems automatically apply their rule base and decrease their bandwidth usage.

In order to determine whether or not the additional amount of bandwidth will cause a conflict with current bandwidth consumption, respective magnitudes of bandwidth consumption are determined on each respective one of a plurality of the data links in an end-to-end path between the specific data processing system and the resource. Accordingly, a bandwidth usage conflict is determined on a hop-by-hop basis. Assume that a specific data link has been identified, on which the session requested by the specific data processing system will cause a bandwidth conflict. Then, the other data processing systems that are currently consuming bandwidth on the specific data link need to be contacted in order to start the negotiations about re-adjustment of the currently ongoing consumption of bandwidth on the specific data link. The contacting can be initiated by means of broadcasting a request to the community or to the other data processing systems to enter negotiations with respect to bandwidth consumption on the specific data link. This approach enables to resolve the conflict by involving the relevant ones of the data processing systems, thus maintaining integrity of the ongoing data communication sessions of the data processing systems not playing a role in the conflict. In an embodiment of the method according to the invention, information about an outcome of the negotiations is made available to all data processing systems of the community. As a result, each individual one of the data processing systems can take into account the outcome of previous negotiations when determining whether or not to relinquish bandwidth to another one of the data processing systems and, if so, how much, if requested to participate in a future negotiation.

If negotiations cannot readily solve the bandwidth problem, one or more of the other data processing systems

In a further embodiment of the method of the invention, the specific data communication session is prevented from being initiated if the negotiating is not completed within a pre-determined time period. For example, the specific data processing system or its representative may actively cancel the request for the specific data communication session.

The concept “pre-determined time period” refers to a time period of pre-determined length. The pre-determined length may be fixed in advance or may be made dependent on the conditions in the community. Preferably, the negotiations resolve the conflict before a new conflict arises. If the current conflict is not resolved before a new conflict arises, the new conflict may involve one or more of the data processing systems already involved in the negotiations about the current conflict.

For example, the current conflict relates to a specific data link and the new conflict relates to a further data link. A particular one of the other data processing systems consuming bandwidth on the specific data link of the current negotiations is also consuming bandwidth on the further data link. The particular other data processing system therefore has to conduct two negotiations at the same time. If conducting multiple negotiations at the same time puts too high a burden on the data processing capabilities of the particular other data processing system, the negotiating may then preferably be delegated to a dedicated community server, running respective software agents that represent the respective interests of the respective active data processing systems at the negotiations.

As another example, the current conflict relates to a specific data link and the new conflict relates to the same specific data link. The current negotiations may then be concluded or aborted, whereupon new negotiations get started, now with a new participant in the form of the data processing system whose new request has given rise to the new conflict. Depending on the size of the community and the number of ongoing data communication sessions, not putting an upper limit on the time period reserved for successfully concluding negotiations, may result in prolonged negotiations involving a number of data processing systems that increases with time.

The above describes a first method of managing bandwidth consumption from the point of view of the specific data processing system requesting the reduction of bandwidth or from the point of view of the representative of the specific data processing system to the community. Below, a second method is described of managing bandwidth consumption from the point of view of another data processing system, or its representative to the community, that is currently consuming bandwidth in an ongoing data communication session on the data network. The first method and the second method form each other's complement in the sense that the first method specifies actions of a data processing system requesting one or more others to relinquish some bandwidth, and the second method specifies other actions of another data processing system receiving a request to relinquish some bandwidth. Note that a particular data processing system of the community or its representative for the purpose of managing bandwidth consumption, may assume at one moment the role of the requesting data processing system and, at another moment, the role of the data processing system being requested to relinquish bandwidth.

Accordingly, the invention also relates to a method of managing bandwidth consumption of a community of data processing systems connected to a data network. The data network comprises a plurality of nodes interconnected through data links. The method comprises: receiving a request to participate in a negotiation with a specific data processing system about a reduction in an amount of bandwidth currently consumed on a specific one of the data links; and determining a magnitude of the reduction under control of a previous reduction in bandwidth consumption, offered by the specific data processing system in a previous negotiation.

Within this context, reference is made to game theory. Game theory is a well-known branch of applied mathematics and relates to modeling the behavior of an individual in a strategic situation as making choices in dependence on choices made by others. For example, a first individual seeks cooperation from a second individual in order to solve a problem. If the first individual receives the cooperation from the second individual, the first individual may reward this feat by means of cooperating with the second individual if the second individual requests cooperation in the near future. If the second individual refuses to cooperate with the first individual, the first individual may punish the second individual by refusing cooperation if the second individual requests cooperation in the near future. If the second individual does cooperate, but only to some limited extent, the first individual may put some restrictions on cooperation with the second individual if the second individual requests cooperation in the near future. Accordingly, the decision about whether to cooperate or refuse to cooperate depends on a history of previous interactions by taking into account the responses of the second individual to one or more previous requests for cooperation from the first individual. An embodiment of the method of the invention may therefore use game theory to control the negotiating.

Note that the previous negotiation may, but need not, have involved the data processing system that is currently being requested to give up some bandwidth. The community of data processing systems may be kept informed about the results of all negotiations. As a result, each particular one of the data processing systems of the community will have been able to gather information about the behavior of any other data processing system of the community involved in one or more past negotiations. When requested to give up some bandwidth, a particular data processing system may respond in dependence on the information gathered about the requesting data processing system.

In a further embodiment of the method, the magnitude is determined under control of an attribute of the specific data communication session other than the bandwidth required.

The attribute may take into account, e.g., the character of the content information of the specific data communication session, the time of the day of the specific data communication session, the day of the week, the identity of the specific data processing system, etc. For example, assume that the content information of the specific data communication session relates to a live broadcast via the data network. The data communication systems of the community may have been configured or programmed to relinquish more of their bandwidth sooner than in case the content information of the specific data communication session relates to a streaming of a pre-recorded video. As another example, assume that the identity of the specific data processing system reveals that the specific data processing system has not often been involved in a bandwidth conflict. This may imply that the specific data processing system is active less frequently than data processing systems that are frequently involved in bandwidth conflicts. The data communication systems of the community may have been configured or programmed to relinquish more of their bandwidth sooner to a session of such specific data processing system than to other data processing systems that are frequently involved in bandwidth conflicts. For this to work, each respective one of the data processing systems may keep a history of respective conflicts with further data processing systems, in which the respective data processing system was involved in the past. Accordingly, the attribute may be used to weigh the rules applied by the other data processing systems when considering relinquishing some bandwidth on the bottleneck data links.

In a further embodiment of the method, the magnitude is determined under control of an identity of a further one of the data processing systems participating in the negotiation.

The reduction in bandwidth, offered by the data processing system receiving the request, may also depend on the past behavior of further data processing systems participating in the current negotiation. For example, if some of the further data processing systems have a past of consistently refusing to give up a fair amount of bandwidth, it may be advisable to not relinquish bandwidth too quickly if at all.

The invention further relates to first control software on a computer-readable medium for being installed on a data processing system. The first control software is configured for managing bandwidth consumption of a community of data processing systems connected to a data network. The data network comprises a plurality of nodes interconnected through data links. The first control software comprises: first instructions for determining an additional amount of bandwidth required for a specific data communication session of a specific one of the data processing systems with a resource on the data network before the specific data communication session is initiated; second instructions for determining if the additional amount of bandwidth causes a conflict with current bandwidth consumption on at least a specific one of data links; and third instructions for, if the additional amount of bandwidth causes the conflict with the current bandwidth consumption: identifying one or more other ones of the data processing systems currently involved in the bandwidth consumption on the specific data link; and initiating resolving the conflict by means of negotiating with the one or more other data processing systems a respective reduction in a respective other amount of bandwidth currently consumed by a respective one of the other data processing systems. The first control software may comprise fourth instructions for preventing the specific data communication session from being initiated if the negotiating is not completed within a pre-determined time period.

The above describes the first control software for managing bandwidth consumption from the point of view of a specific data processing system requesting the reduction of bandwidth or from the point of view of the representative of the specific data processing system to the community. Below, second control software is described of managing bandwidth consumption from the point of view of another data processing system, or its representative to the community, that is currently consuming bandwidth in an ongoing data communication session on the data network. The first control software and the second control software form each other's complement in the sense that the first control software specifies actions of a data processing system requesting one or more others to relinquish some bandwidth, and the second control software specifies other actions of another data processing system receiving a request to relinquish some bandwidth. Note that a particular data processing system of the community may assume at one moment the role of the requesting data processing system and, at another moment or at the same moment if involved in multiple data communication sessions via the data network at the same time, the role of the data processing system being requested to relinquish bandwidth. Accordingly, the first control software and the second control software can be merged in a single package for being installed on a data processing system, or a computer that represents the data processing system at the process of managing bandwidth.

The invention further relates to second control software on a computer-readable medium. The second control software is configured for managing bandwidth consumption of a community of data processing systems connected to a data network. The data network comprises a plurality of nodes interconnected through data links. The second control software comprises: fifth instructions for receiving a request to participate in a negotiation with a specific data processing system about a reduction in an amount of bandwidth currently consumed on a specific one of the data links; and sixth instructions for determining a magnitude of the reduction under control of a previous reduction in bandwidth consumption, offered by the specific data processing system in a previous negotiation.

An embodiment of the second control software comprises seventh instructions for determining the magnitude under control of an attribute of the specific data communication session other than the bandwidth required.

A further embodiment of the second control software comprises eighth instructions for determining the magnitude under control of an identity of a further one of the data processing systems participating in the negotiation.

The feature “computer-readable medium”, introduced above, includes, for example, an optical disc or another optical memory, a hard disk drive or another magnetic memory, a solid-state memory, etc.

The invention further relates to a first data processing system having a network interface for data communication via a data network that comprises a plurality of nodes interconnected through data links. The first data processing system is configured for: determining an additional amount of bandwidth required for a specific data communication session of the first data processing system via the data network before the specific data communication session is initiated; determining if the additional amount of bandwidth causes a conflict with current bandwidth consumption on at least a specific one of data links; and if the additional amount of bandwidth causes a conflict with the current bandwidth consumption: identifying one or more other data processing systems currently involved in the bandwidth consumption on the specific data link; and initiating resolving the conflict by means of negotiating with the one or more other data processing systems a respective reduction in a respective other amount of bandwidth currently consumed by a respective one of the other data processing systems.

The invention also relates to a second data processing system, having a network interface for data communication via a data network that comprises a plurality of nodes interconnected through data links. The second data processing system is configured for: receiving a request to participate in a negotiation with a specific other data processing system about a reduction in an amount of bandwidth currently consumed on a specific one of the data links; and determining a magnitude of the reduction under control of a previous reduction of bandwidth consumption, offered by the specific data processing system in a previous negotiation.

Again note that the first data processing system and the second data processing system form each other's counterpart and collectively operate to manage bandwidth consumption on the data network. A particular data processing system may therefore include both the first data processing system and the second data processing system as defined above, so as to be able to play the roles of both.

### BRIEF DESCRIPTION OF THE DRAWING

The invention is explained in further detail, by way of example and with reference to the accompanying drawing, wherein:

FIGS. 1 and 2 are diagrams of a first network environment;

FIG. 3 is a diagram of a second network environment;

FIG. 4 is a diagram of a first method of the invention; and

FIG. 5 is a diagram of a second method of the invention.

Throughout the Figures, similar or corresponding features are indicated by same reference numerals.

### DETAILED EMBODIMENTS

The invention relates to a decentralized manner of managing bandwidth consumption of a community of data processing systems, e.g., a community of clients, that communicate via a data network. Before a new data communication session is started by a specific one of the clients, the state of the data network is determined, in terms of bandwidth currently being used by the community on one or more data links. If the new data communication session is started by the specific client, one or more of the data links may become a network bottleneck as a result of which network performance may be adversely affected as perceived by the already active ones of the clients. Assume now that the new session requires an amount of bandwidth that would create a network bottleneck at a certain data link. That is, assume that the new session would create a conflict with regard to available or pre-allocated bandwidth at the certain data link. Then, the specific client and those particular ones of the clients that share bandwidth on the certain data link start negotiating about releasing amounts of bandwidth by one or more of the particular clients on the certain data link. Upon successful completion of the negotiation, the bandwidth on the certain link is re-distributed so that the new session can start. The bandwidth is measured hop-by-hop, as described in the publications referred to above in the background art section.

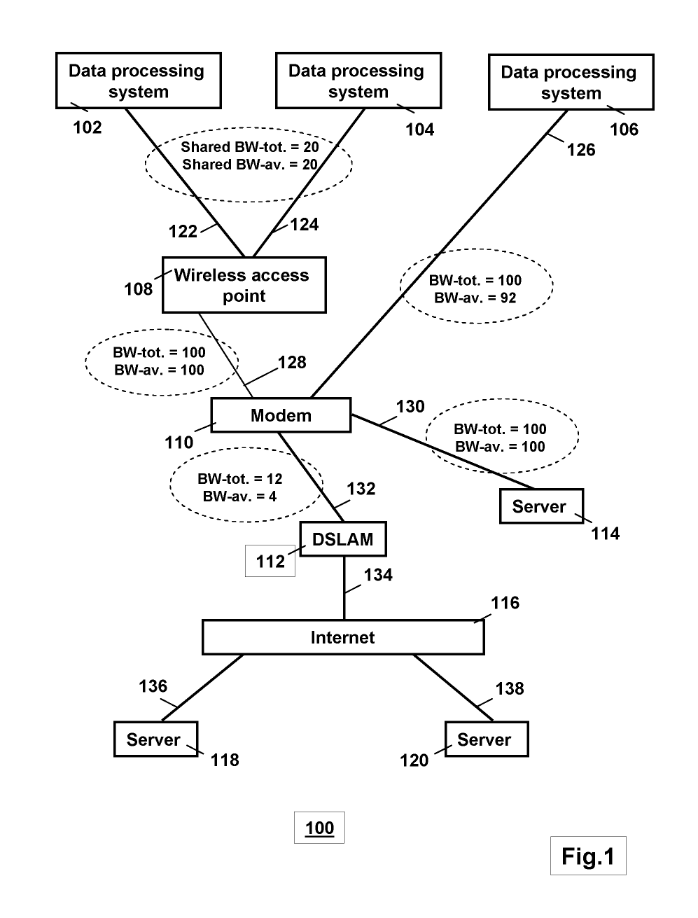

FIG. 1 is a diagram of a first data network environment 100. The first data network environment 100 comprises a first data processing system 102, a second data processing system 104, a third data processing system 106, a wireless access point 108, a modem 110, a digital subscriber line access multiplexer (DSLAM) 112, a first content server 114, a data network 116, e.g., the Internet, a second content server 118 and a third content server 120. Each of the first data processing system 102, the second data processing system 104, and the third data processing system 106 may be a physical entity (e.g., an apparatus) or a data processing system (i.e., an entity with spatially distributed and interconnected functionalities such as a home network).

The first data processing system 102 is connected to the wireless access point 108 via a first data link 122 that is a wireless connection. The second data processing system 104 is connected to the wireless access point 108 via a second data link 124 that is a wireless connection. The third data processing system 106 is connected to the modem 110 via a third data link 126 that is a wired connection. The wireless access point 108 is connected to the modem 110 via a fourth data link 128 that is a wired connection. The first content server 114 is connected to the modem 110 via a fifth data link 130 that is a wired connection. The modem 110 is connected to the DSLAM 112 via a sixth data link 132 that is a digital subscriber line (DSL). The DSLAM 112 is connected to the Internet via a seventh data link 134 that is a high-speed Internet backbone. The second content server 118 is connected to the Internet 116 via an eighth data link 136 and the third content server 120 is connected to the Internet 116 via a ninth data link 138.

Assume that the each of the first data processing system 102, the second data processing system 104 and the third data processing system 106 is capable of initiating or terminating data communications sessions with any of the first server 114, the second server 118 and the third server 120.

Assume further that bandwidth is much more limited on the first data link 122, the second data link 124, the third data link 126, the fourth data link 128, the fifth data link 130 and the sixth data link 132, than on each of the seventh data link 134, the eighth data link 136 and the ninth data link 138. Accordingly, operational conditions of the first data network environment 100 that involve bandwidth are only considered, in this example, with respect to the first data link 122, the second data link 124, the third data link 126, the fourth data link 128, the fifth data link 130 and the sixth data link 132.

Assume that the following bandwidth limitations are applicable. The total bandwidth available to the first data link 122 and the second data link 124 combined is, e.g., 20 Mbits/sec, and is shared by the first data link 122 and the second data link 124. The total bandwidth of the third data link 126 is, e.g., 100 Mbits/sec. The total bandwidth of the fourth data link 128 is also 100 Mbits/sec. The total bandwidth of the fifth data link 130 is also 100 Mbits/sec. And the total bandwidth of the seventh data link 132 is, e.g., 12 Mbits/sec.

Consider now the following state of the first data network environment 100: the first data processing system 102 is not using any bandwidth on the first data link 122; the second data processing system 104 is not using any bandwidth on the second data link 124; the third data processing system 106, however, is using 8 Mbits/sec on the third data link 126 as well as on the sixth data link 132 in a data communication session with, e.g., the third server 120. Accordingly, the available bandwidth on the third data link is 92 Mbits/sec, and the available bandwidth on the seventh data link 132 is 4 Mbits/sec.

Consider now a first scenario, wherein the second data processing system 104 starts a new data communication session and attempts to set up a connection with the second server 118. The new data communication session requires a bandwidth of, say, 8 Mbits/sec. Before the new data communication session is set up, the available bandwidth is determined on the end-to-end path between the second data processing system 104 and the second server 118. The end-to-end path includes: the second data link 124 between the second data processing system 104 and the wireless access point 108; the fourth data link 128 between the wireless access point 108 and the modem 110; the sixth data link 132 between the modem 110 and the DSLAM 112, the seventh data link 134 between the DSLAM and the Internet 116 and the eighth data link 136 between the Internet 116 and the second server 118.

The available bandwidth can be determined in a variety of manners known in the art: a first manner is to carry out an end-to-end measurement, a second manner is to measure bandwidth at a network node, e.g., at the modem 110 or at the DSLAM 112, and a third manner is to carry out hop-by-hop measurements.

As to the end-to-end measurement, the second data processing system 104 can measure end-to-end bandwidth between itself the second server 118; and the (currently active) third data processing system 106 can measure the end-to-end bandwidth between itself and the third server 120. Both the second data processing system 104 and the third data processing system 106 measure the total bandwidth and the available bandwidth, the interesting parameters for determining potential conflicts. In end-to-end measurements, both the second data processing system 104 and the third data processing system 106 will measure a total bandwidth of 12 Mbits/sec and an available bandwidth of 4 Mbits/sec. This is no surprise, since both the second data processing system 104 and the third data processing system 106 share the same bottleneck, namely the sixth data link 132, which is the same for both the total bandwidth and the available bandwidth. Based on the measurements, the conflict can be resolved between the second data processing system 104 and the third data processing system 106. The conflict can be resolved, for example, by using negotiations between the second data processing system 104 and the third data processing system 106, based on, e.g., game theory, or by using individual sets of pre-determined rules per individual one of the second data processing system 104 and the third data processing system 106 that specify in advance how to behave when bandwidth has to be re-allocated.

As to measuring bandwidth at a network node, consider measuring the bandwidth at, e.g., the modem 110 or the DSLAM 112. The modem 110 can measure the bandwidth of the fourth data link 128 (between the wireless access point 108 and the modem 110) and of the sixth data link 132 (between the modem 110 and the DSLAM 112). The DSLAM 112 can measure the bandwidth of the sixth data link 132 (between the modem 110 and the DSLAM 112) and of the seventh data link 134 between the DSLAM and the Internet 116. Typically, the sixth data link between the modem 110 and DSLAM 112 will be a bottleneck because the total bandwidth is limited. This is the case in this example as well. The conflict between the second data processing system 104 and the third data processing system 106 can be resolved based on bandwidth measurements made by, e.g. the modem 110 or the DSLAM 112. The conflict can be resolved by means of, for example, using negotiations between the second data processing system 104 and the third data processing system 106, based on, e.g., game theory or by means of using individual sets of pre-determined rules per individual one of the second data processing system 104 and the third data processing system 106 that specify in advance how to behave when bandwidth has to be re-allocated.

As to measuring hop-by-hop, i.e., measuring the bandwidth of each individual one of the data links in an end-to-end path, such measurements conducted by the second data processing system 104 and the third data processing system 106 will show that the bottleneck is on the sixth data link 132 between the modem 110 and the DSLAM 112, and the conflict between the second data processing system 104 and the third data processing system 106 can be resolved by means of, e.g., using negotiations between the second data processing system 104 and the third data processing system 106 based on, e.g., game theory, or by means of using individual sets of pre-determined rules per individual one of the second data processing system 104 and the third data processing system 106 that specify in advance how to behave when bandwidth has to be re-allocated.

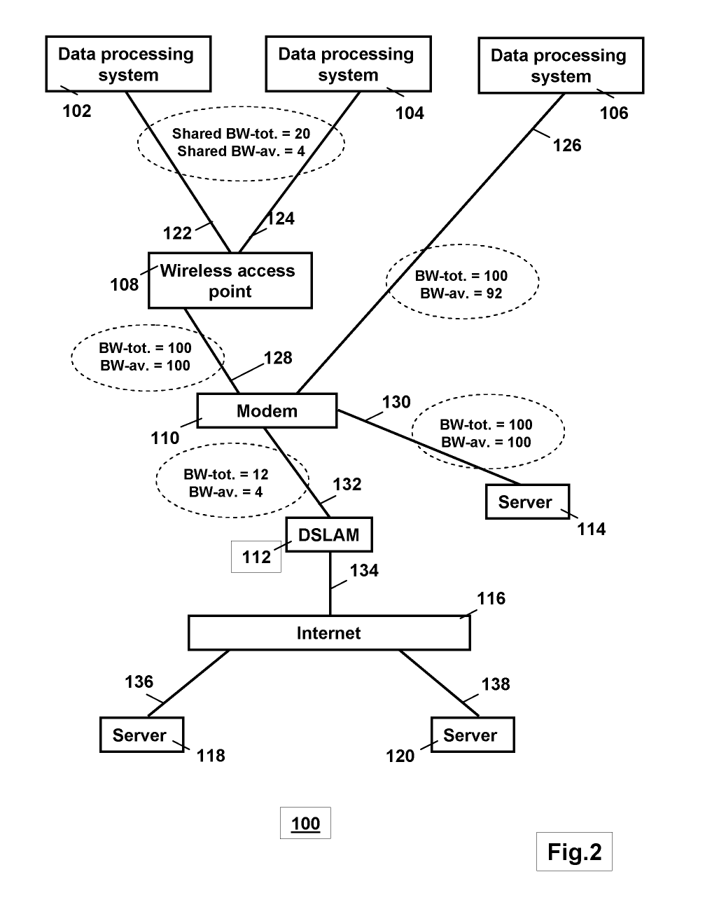

Reference is now made to FIG. 2. FIG. 2 is a diagram of the first data network environment 100 as discussed with reference to FIG. 1. Consider now a second scenario, wherein the current state of the first data network environment 100 is that the third data processing system 106 is consuming a bandwidth amount of 8 Mbits/sec in a current data communication session with the third server 120, as in the first scenario above, and the first data processing system 102 is also consuming bandwidth in an amount of 16 Mbits/sec in another current data communication session with the first server 114. Also assume that the first data processing system 102 is not configured for resolving any bandwidth conflict through negotiations.

When the second data processing system 106 wants to set up a connection with the second server 118 for a data communication session of 8 Mbits/sec, bandwidth is measured first. As mentioned above, this can be accomplished by carrying out an end-to-end measurement, or to measure bandwidth at a network node, e.g., at the modem 110 or at the DSLAM 112, or to carry out hop-by-hop measurements, or by using information from other sources, e.g., through Simple Network Management Protocol (SNMP). As known, SNMP is included in the Internet Protocol Suite and operates on management data, e.g., configuration data, exposed by the data processing systems. These management data can be queried by dedicated managing software applications.

As to end-to-end measurements: the end-to-end measurements by the second data processing system 104 and the third data processing system 106 will be the same as in the first scenario above, measuring a total bandwidth of 12 Mbits/sec and available bandwidth of 4 Mbits/sec on the sixth data link 132 between the modem 110 and the DSLAM 112. This would seem to require a conflict resolution between the second data processing system 104 and the third data processing system 106. However, suppose that the second data processing system 104 and the third data processing system 106 could agree on each using 6 Mbits/sec, dividing the total of 12 Mbits/sec fairly between them. This would not solve the problem, because a bottleneck of 4 Mbits/sec of available bandwidth for the second data processing system 106 is also a result of the bandwidth available in the first wireless data link 122 and the second wireless data link 114.

As to measuring bandwidth at a network node, e.g., at the modem 110 or at the DSLAM 112: this would result in a similar assessment as in the first scenario discussed above, leading to the incorrect conclusion that the second data processing system 104 and the third data processing system 106 can resolve the conflict through negotiations.

As to measuring hop-by-hop, i.e., measuring the bandwidth of each individual one of the data links of an end-to-end path, such measurements conducted by the second data processing system 104 and the third data processing system 106 will not only show that a first bottleneck is present on the sixth data link 132 between the modem 110 and the DSLAM 112, but a hop-by-hop measurement by the second data processing system 104 will also reveal a second bottleneck on the second data link 124 due to an amount of bandwidth of 16 Mbits/sec being occupied by the first data processing system 102 on the wireless connection with the wireless access point 108. As this conflict cannot be resolved through negotiations with the first data processing system 102, as the latter is not configured for this, there is no need for the second data processing system 104 to enter negotiations with the third data processing system 106.

Accordingly, hop-by-hop measurements enable to identify proper individual bottlenecks and to use conflict resolving strategies that take into account multiple bottlenecks involving different data processing systems per different one of the bottlenecks.

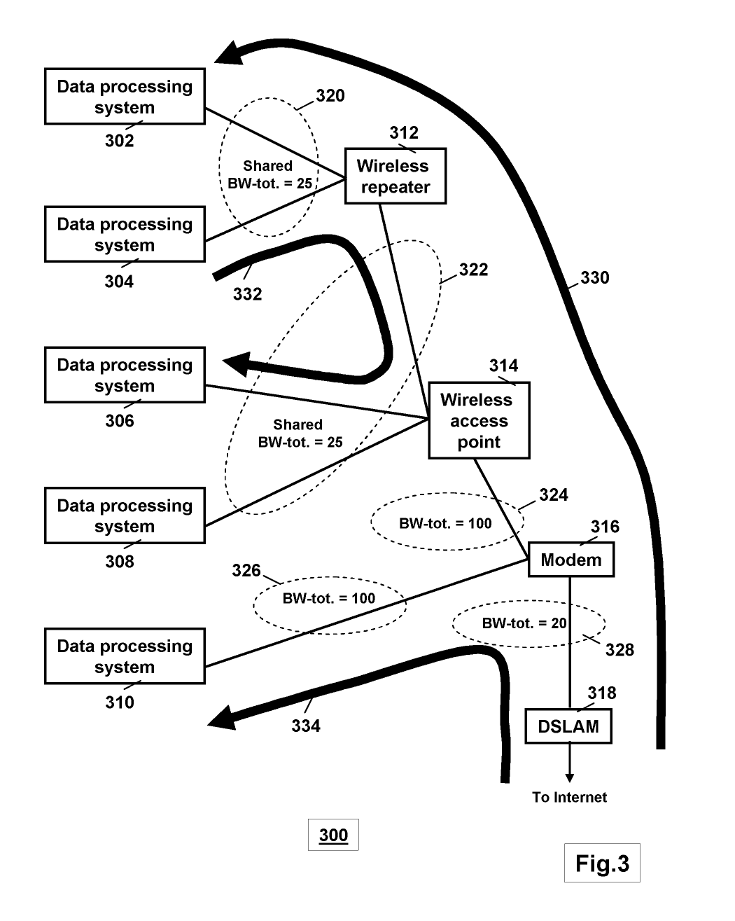

FIG. 3 is a diagram of a second data processing environment 300. The second data processing environment 300 comprises: a first data processing system 302; a second data processing system 304; a third data processing system 306; a fourth data processing system 308; a fifth data processing system 310; a wireless repeater 312; a wireless access point 314; a modem 316; and a DSLAM 318.

The first data processing system 302 and the second data processing system 304 are connected to the wireless repeater 312 via a first segment 320 of wireless data links 320 using, e.g., IEEE 802.11n, a modulation standard for a wireless LAN. The total amount of bandwidth of the first segment 320 is, e.g., 25 Mbits/sec and is shared by the first data processing system 302, the second data processing system 304 and the wireless repeater 312. The wireless repeater 312, as well as the third data processing system 306 and the fourth data processing system 308 are connected to the wireless access point 314 via a second segment 322 of wireless data links using, e.g., IEEE 802.11n. The total amount of bandwidth of the second segment 322 is, e.g., 25 Mbits/sec and is shared by the third data processing system 306, the fourth data processing system 308, the wireless repeater 312 and the wireless access point 314. The wireless access point 314 is connected to the modem 316 via, e.g., a 100BASE-T Ethernet connection 324 using a twisted pair of copper wires. A 100BASE-T Ethernet connection runs at 100 Mbits/sec. The fifth data processing system 310 is connected to the modem 316, via a 100BASE-T Ethernet connection 326 that is also capable of 100 Mbits/sec. The modem 316 is connected to the DSLAM 318 via a 20 Mbits/sec DSL connection 328 to the Internet (not shown here). For completeness, it is remarked here that the wireless repeater is a dual-band repeater configured for operating on two (or more) disjoint frequency bands.

Consider the following scenario, wherein the data traffic is directional and wherein it is assumed that all currently ongoing data communications sessions are about video streams, so that bandwidth usage is fairly constant over time. The first data processing system 302 is receiving a first data stream 330 of 5 Mbits/sec from the Internet, via the DSLAM 318, the modem 316, the wireless access point 314 and the wireless repeater 312, in that order. The bit-rate of the first data stream 330 could be adjusted to as few as 4 Mbits/sec and as much as 8 Mbits/sec, e.g. through using SVC or multi-bit-rate encoding. The third data processing system 306 is receiving a data stream 332 of 10 Mbits/sec from the second data processing system 304. The bit rate of the second data stream 332 could be adjusted to as few as 5 Mbits/sec and to as much as 12 Mbits/sec using SCV or multi-bit-rate encoding. Note that the second data stream 332 is present twice on the second segment 322 of wireless data links: the second data stream 332 is communicated from the second data processing system 304 via the wireless repeater 312 to the wireless access point 314, and from the wireless access point 314 to the third data processing system 306. This double presence of the second data stream 332 causes a double load of 20 Mbits/sec on the second segment 332. The fifth data processing system 310 is receiving a third data stream 334 of 8 Mbits/sec from the Internet, via the DSLAM 318 and the modem 316. The fifth data processing system 310 is not configured for processing video data whose data rate can be changed based on SVC or multi-bit-rate encoding.

Note that there is currently a single bottleneck, and this bottleneck is present in the second segment 322. The first data processing system 302 would like more bandwidth, but can only receive a data stream of 5 Mbits/sec in the second segment 332, although the first segment 320, the Ethernet connection 324 and the DSL connection 328 currently have more bandwidth available for the first data processing system 302. Also, the second data processing system 304 and the third data processing system 306 would like more bandwidth in the second segment 322 as well.

Now, consider that the fourth data processing system 308 becomes active and joins in. The fourth data processing system 308 requests a video stream from the Internet with a bit-rate of 8 Mbits/sec. Assume that the fourth data processing system is not configured for processing video encoded in a SVC encoding scheme or in multi-bit-rate encoding scheme and, accordingly, cannot use anything less than 8 Mbits/sec. On the DSL connection 328, a bandwidth of only 7 Mbits/sec is available of the total bandwidth of 20 Mbits/sec, owing to the fact that the DSL connection 328 currently supports the first data stream 330 of 5 Mbits/sec and the third data stream 334 of 8 Mbits/sec. In the second segment 322 that supports the double presence of the second video stream 332, no bandwidth is currently available.

However, the fourth data processing system 308 could receive the requested stream, if the first data processing system 302, the second data processing system 304 and the third data processing system 306 cooperate. The second data processing system 304 and the third data processing system 306 need to cooperate by releasing bandwidth on the second segment 322, and the first data processing system 302 needs to cooperate by releasing 1 Mbits/sec of bandwidth on the DSL connection 328. Accordingly, the bandwidth problem can be resolved if: the first data processing system 302 releases 1 Mbits/sec of bandwidth, in both the second segment 322 and on the DSL connection 328; and if the second data processing system 304 decreases the bit-rate of the second video stream 332 from 10 Mbits/sec to 6.5 Mbits/sec; and if the third data processing system 306 decreases the bit-rate of the second stream 332 from 10 Mbits/sec to 6.5 Mbits/sec, thus releasing an additional bandwidth of 7 Mbits/sec on the second segment 322.

If these bandwidth re-adjustments are not properly carried out, the following could go wrong.

If the second data processing system 304 and the third data processing system 306 were to reduce their bit-rates, this would free up the bottleneck in the second segment 322 for the first data processing system 302. If the first data processing system 302 increased its bit-rate to 8 Mbits/sec, this would leave no bandwidth for the video stream to the fourth data processing system 308.

If the first data processing system 302 lowered its bit-rate first, then the second data processing system 304 and the third data processing system 306 could increase their bit-rates in the second segment 322 and, as a result, leave no bandwidth for the video stream to the fourth data processing system 308.

If the first data processing system 302 reduced its bit-rate, but the second data processing system 304 and the third data processing system 306 did not cooperate, it would not free up enough bandwidth in the second segment 322 for the video stream to the fourth data processing system 308. Accordingly, the first data processing system 302 would then have to increase its bit-rate again.

If the second data processing system 304 and the third data processing system 306 lowered their bit-rates first, but the first data processing system 302 did not cooperate, it would not free up enough bandwidth in the second segment 322 bandwidth for the video stream to the fourth data processing system 308.

Therefore, the following strategy is proposed:

The fourth data processing system 308 first performs a hop-by-hop measurement of the bandwidth. As a result, the fourth data processing system 308 finds out there are bottlenecks in the second segment 322 and on the DSL connection 328. The fourth data processing system 308 then transmits a communication (e.g., in a broadcast) to the first data processing system 302, the second data processing system 304, the third data processing system 306 and the fifth data processing system 310, requesting bandwidth release in the second segment 322 and on the DSL connection 328. Note that the first data processing system 302 can specify the bandwidth per data link: 1 Mbits/sec on the DSL connection 328 and 8 Mbits/sec on the second segment 322.

The first data processing system 302, the second data processing system 304, and the third data processing system 306 respond to the request, by indicating what they can contribute on the second segment 322 and on the DSL connection 328. For example, the first data processing system 302, the second data processing system 304, the third data processing system 306 communicate to the fourth data processing system 308 information on their useful bit-rate ranges as well as information about their currently used bandwidth. The fourth data processing system 308 receives and processes this information. The fourth data processing system 308 finds out that the conflict can be solve if the first data processing system 302 releases 1 Mbits/sec, and if the second data processing system 304 and the third data processing system 306 each release 3.5 Mbits/sec. The fourth data processing system 308 can request this directly from the data processing systems involved, or use a broadcast again. The idea of using broadcast is that all relevant ones of the data processing systems can see what is happening. For example, each of the second data processing system 304 and the third data processing system 306 gets notified of the fact that 3.5 Mbits/sec is requested from itself, as well as from the other, which they would not know if the fourth data processing system 308 had used unicast. A same effect could be accomplished by means of using alternative approaches for broadcasting, such as the publish/subscribe mechanism of Universal Plug and Play (UPnP). Assume now that the first data processing system 302, the second data processing system 304, the third data processing system 306 comply with the request from the fourth data processing system 308 and release the amount of bandwidth requested. Then, after the fourth data processing system 308 measures the increase in available bandwidth in the second segment 322 and on the DSL connection 328, the fourth data processing system 308 is ready to initiate receiving the requested video stream.

The problems mentioned earlier are avoided, because a collaborative/cooperative model is being used. If bandwidth is available, any of the data processing systems can just start to use it. However, if bandwidth becomes available to a particular data processing system after another data processing system made a request for bandwidth, then the particular data processing system does not increase its bit-rate. All cooperating data processing systems in the network, e.g., a home network, see this, as a result of broadcast being used for the bandwidth requests.

The collaborative/cooperative model for initiating a re-allocation of useable bandwidth among a community of end-user systems is relevant to a scenario wherein, for example, one or more of the already active ones of the data processing systems are consuming electronic content information being streamed or being downloaded via the data network, and wherein the electronic content information is provided in a multi-bitrate encoding technique. Known examples of multi-bitrate encoding techniques are Scalable Video Coding (SVC); Dynamic Adaptive Streaming over HTTP (DASH); Multi Description Coding (MDC); simulcasting electronic content information in multiple data streams, each at a different bitrate, and a combination of these techniques. In addition, each of these multi-bitrate encoding techniques may be complemented by in-band error correction techniques and/or out-of-band error correction techniques in order to increase the robustness. However, this introduces redundancy and comes at the expense of an increase in bandwidth consumption.

As known, Scalable Video Coding (SVC) is a layered encoding scheme wherein the file or the stream of a piece of electronic content information, e.g., video, is encoded in a base layer and one or more enhancement layers. The base layer may be decoded independently of any of the enhancement layers. The encoding/decoding of the enhancement layer typically depends on the base layer and/or on other enhancement layers. The base layer and one or more enhancement layers may be transported individually, or jointly in a multiplexed fashion, or in a file. This technology is typically applied to encode a video stream targeting multiple data processing systems, multiple data networks, and varying bandwidth conditions. The bandwidth adjustment may be performed at the server side or at an intermediate node in the data network between the server and the data processing system, by simply dropping or adding enhancement layers. If the video is streamed in a multicast fashion, an intermediate node may drop an enhancement layer to reduce bandwidth in the data paths to some of the connected data processing systems, while retaining the current bandwidth in other data paths to other ones of the data processing systems.

As to Dynamic Adaptive Streaming over HTTP (DASH): consider a video file that is organized in storage as a sequence of segments, and each respective one of the segments having a play-out time at the receiving data processing system of typically a couple of seconds. The server has available a particular piece of video content information as a number of different video files. A specific one of the video files is encoded at a specific bitrate that is different from the bitrate, at which another one of the video files is encoded. Depending on the actual bandwidth currently available to the data processing system, the data processing system requests a next segment of the same video content information that is encoded at a bitrate that matches the available bandwidth. This technology is typically applied in order to encode a video stream which will be transmitted over a data network under varying bandwidth conditions. The bandwidth of the video stream can be adjusted every couple of seconds.

In a Multiple Description Coding (MDC) scheme, a video file or a video stream is encoded in multiple representations that are referred to as “descriptions”. These representations are complimentary but can be independently encoded. The quality is higher if more descriptions are received. This technology is typically used in ad-hoc data networks or in peer-to-peer networks, where there are multiple parallel routes available in the data network from a source of the video file, or of the video stream, to the destination (here: the receiving data processing system), each route having its own bandwidth limitation and/or bandwidth variation.

As to the simulcast of streams at different bitrates, the term “simulcast” and the expression “simultaneous broadcast” refers to the process of broadcasting the same electronic content information across multiple media at the same time.

Typically, a video file is encoded at one bitrate, or at a number of predetermined bitrates. Techniques are available that allow for a near seamless reduction of the bandwidth allocated to a video bitstream. Some wavelet techniques for images have this property. A difference between simulcast and the other, more refined forms of multi bitrate encoding is the manner wherein the switching from one bitrate to another bitrate is carried out.

The following paragraphs discuss some scenarios to illustrate operation of the invention.

In a scenario “A”, pieces of electronic content information are being streamed to, or downloaded by, active ones of the data processing systems of the community, e.g., the first data processing system 102 and the third data processing system 106. The pieces of electronic content information being streamed and/or downloaded are each encoded in a multi-bitrate encoding scheme (not necessarily the same scheme). Another data processing system of the community, e.g., the second data processing system 104, now requests delivery of an additional piece of content information in a data stream at a single bitrate of, e.g., 4 Mbits/sec. The second data processing system 104 determines via hop-by-hop measurements the network bottleneck. In this case, the bottleneck is the sixth data link 132 between the modem 110 and the DSLAM 112. The second data processing 104 initiates negotiations with those among the data processing systems of the community, that are using this sixth data link 132. In this case, the third data processing system 106 is using the sixth data link 132 for a data stream of 8 Mbits/sec from the third content server 120. The negotiation between the second data processing system 104 and the third data processing system 106 is about whether the third data processing system 106 is willing to reduce its bandwidth consumption on the sixth data link 132. Assume that the content information in the data stream from the third content server 120 to the third data processing system 106 is encoded in an SVC coding scheme. The third data processing system 106 can reduce its bandwidth consumption by means of selecting a version of the content information that uses a lower bandwidth. This may be achieved, e.g., by dropping enhancement layers of the SVC-encoded data stream. Typically, each layer of the SVC encoded data stream is streamed to a different multicast address and/or port number. The bandwidth of the requested data stream to the third data processing system 106 may be controlled by opening or closing one or more of the connections using, for example, IGMP join/leave control messages. The acronym “IGMP” stands for “Internet Group Management Protocol”, which is a known communication protocol that is used by hosts and adjacent routers on IP networks to establish multicast group memberships. Alternatively, the third content server 120 or a network node in the path between the third content server 120 and the third data processing system 106 (i.e., an intermediate node) reduce the multiplexed SVC file and drop one or more enhancement layers. Alternatively, the third content server 120 or the intermediate node multiplexes all layers of the SVC-encoded stream in a single stream. The third content server 120 or the intermediate node can therefore easily reduce the bandwidth needed for the SVC-encoded stream. For example, if the third data processing system 106 is receiving an SVC-encoded data stream with a base layer of 4 Mbits/sec and two enhancement layers of 2 Mbits/sec each, the negotiations may lead to resolving the bandwidth conflict on the sixth data link 132. As a result of the negotiations, the third data processing system 106 reduces its bandwidth consumption by 4 Mbits/sec by means of dropping the two enhancement layers, thus freeing bandwidth for the data stream of 4 Mbits/sec requested by the second data processing system 104.

In a scenario “B”, pieces of electronic content information are being streamed to, or downloaded by, active ones of the data processing systems of the community, e.g., the first data processing system 102 and the third data processing system 106. Each of the pieces of the electronic content information being streamed and/or downloaded is available at a single bitrate only. Another data processing system of the community, e.g., the second data processing system 104, now requests the second content sever 118 to stream an additional piece of content information. The second content server 118 has the additional piece of content information available as encoded in a multi-bitrate encoding scheme. Upon receipt of the request from the second data processing system 104, the second content server 118 responds by sending a message to the second data processing system 104, notifying the second data processing system 104 of the bitrates available for this additional piece of content information. The second data processing system 104 indicates its preferred, or possible, bitrates. Based on the hop-by-hop measurements it is known which data link(s) form(s) a bottleneck, in this case the sixth data link 132 between the modem 110 and the DSLAM 112. Negotiation with the third data processing system 106 reveals that the bitrate of the data stream, consumed by the third data processing system 106, cannot be reduced without the third data processing system 106 terminating its session. If the third data processing system 106 notifies the second data processing system 104 of the fact that the former does not terminate its current session, the second data processing system 104 proceeds with requesting the second content server 118 that the data of the additional piece of content information be streamed at a bitrate which fits the available bandwidth on the sixth data link 132.

In a scenario “C”, pieces of electronic content information are being streamed to, or downloaded by, active ones of the data processing systems of the community, e.g., the first data processing system 102 and the third data processing system 106. The pieces of electronic content information being streamed and/or downloaded are each encoded in a multi-bitrate encoding scheme (not necessarily the same scheme). Another data processing system of the community, e.g., the second data processing system 104, now requests the second content server 118 to stream an additional piece of content information. The second content server 118 informs the second data processing system 104 of the fact that the additional piece of content information is available in a multi-bitrate encoding scheme. The second data processing system 104 determines the preferred or possible bitrates. Based on hop-by-hop measurements it is known which link(s) form(s) a bottleneck, here the sixth data link 132. The second data processing system 104 initiates negotiations with those among the community of the data processing systems that are currently consuming bandwidth on the bottleneck data links(s), here: only the third data processing system 106. In the negotiations between the second data processing system 104 and the third data processing system 106 various approaches are available to resolve the bandwidth conflict on the bottleneck data links. For example, the third data processing system 106 reduces its bandwidth consumption on the sixth data link 132 by means of requesting the third content server 120 to use a data stream at a bitrate that is reduced by a first amount so as to allow the second data processing system 104 to receive the additional piece of content information in a data stream at a bitrate equal to the first amount relinquished by the third data processing system 106. As another example, the third data processing system 106 reduces its bandwidth consumption on the sixth data link 132 by means of requesting the third content server 120 to use a data stream at a bitrate that is reduced by a second amount, larger than the first amount, so as to allow the second data processing system 104 to receive the additional piece of content information in a data stream at a bitrate equal to the second amount relinquished by the third data processing system 106.

In a scenario “D”, pieces of electronic content information are being streamed to, or downloaded by, active ones of the data processing systems of the community, e.g., the first data processing system 102 and the third data processing system 106. Some of the pieces of electronic content information being streamed and/or downloaded are each encoded in a multi-bitrate encoding scheme (not necessarily the same scheme), whereas each of the other ones of the pieces of electronic content information being streamed and/or downloaded is available only at a fixed bit-rate. Another data processing system of the community, e.g., the second data processing system 104, now requests the second content server 118 to stream an additional piece of content information. The second content server 118 informs the second data processing system 104 of the fact that the additional piece of content information is available in a multi-bitrate encoding scheme. The second data processing system 104 indicates its preferred/possible bitrate. Based on hop-by-hop measurements it is determined which link(s) form(s) a bottleneck. The second data processing system 104 initiates then negotiation to free up bandwidth on the one or more data links that form the bottleneck. Based on the negotiations, approaches are identified to collectively solve the bandwidth conflict. For example, one or more of the active ones of the data processing systems that are consuming bandwidth on the bottleneck data link(s), may relinquish some bandwidth by requesting delivery of their pieces of content information at a lower bit-rate in case their pieces of content information are available in a multi-bitrate coding scheme. One or more other ones of the active data processing systems that are consuming bandwidth on the bottleneck data link(s), may terminate their data communication session, etc.

Consider the situation that a particular data processing system intends to initiate a particular new data communication session that gives rise to one or more possible bandwidth conflicts on a particular data link in the network that now becomes a bottleneck. Negotiations are started with active ones of the data processing systems that are currently consuming bandwidth at the bottleneck. Assume now that a further data processing system intends to initiate a further new data communication session that gives rise to a possible further bandwidth conflict on a further data link in the network that now also becomes a bottleneck. Assume that a certain active one of the data processing systems is currently consuming bandwidth on the bottleneck and on the further bottleneck. This active data processing system is then to participate in two negotiations that run at least partly at the same time. If the active data processing system is not configured for conducting multiple negotiations, or for conducting multiple negotiations in a time-efficient manner, the active data processing system may delegate one or both negotiations to a data processing entity (if available) that is better equipped for conducting multiple negotiations, e.g., a server of the community dedicated to conducting negotiations. Such a community server may then have software agents running that represent the interests of the active data processing systems. As to time-efficiency of the negotiations, consider that the number of bandwidth conflicts per unit of time depends on, among other things, the size of the community of data processing systems. If negotiations tend to last longer than an average length of time between the occurrences of two successive bandwidth conflicts, ongoing negotiations may get affected by the conditions that gave rise to the new bandwidth conflict and, therefore, by the conditions under which the new conflict has to be negotiated. Accordingly, providing a community server to handle the negotiations on behalf of the data processing systems may avoid the rise and fall of conflicts that get never resolved. Alternatively, or in combination with delegating the negotiations to a community server, one may put an upper limit to the maximum duration of the negotiations. If the conflict is not resolved by the end of the time period reserved for the negotiations, the new request for a data communication session, which has given rise to the conflict being negotiated, is not honored. The requesting data processing system has to wait and put in another request.

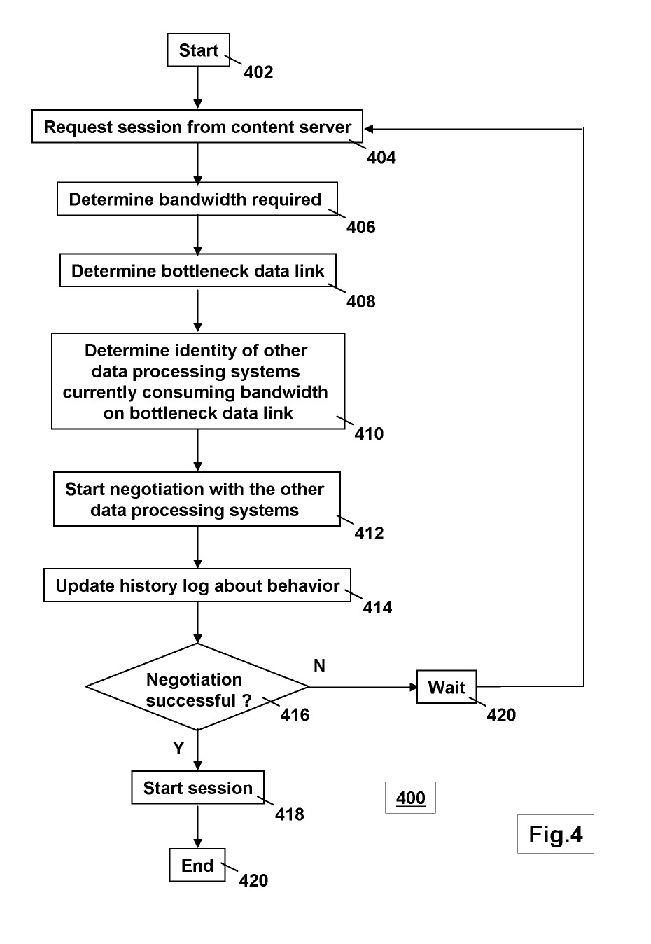

FIG. 4 is a diagram of a first method 400 of managing bandwidth consumption in a community of data processing systems on a data network. The first method 400 illustrates the actions of a specific data processing system that intends in a first step 402 to start a specific data communication session via the data network. The data communication session involves, e.g., the streaming of a video file from a content server via the data network to the specific data processing system.

In a second step 404, the specific data processing system, or its representative, requests the content server to start the data communication session. The content server responds by a message with information about the bandwidth required or, if the video file is available in a multi-bitrate encoding scheme, a message with information about the available bandwidths. The concept “representative” has been discussed above and refers to, for example, a proxy of the specific data processing system, or to a dedicated data processing device or to a community server.

In a third step 406, the specific data processing system, or its representative, receives the information and determines what bandwidth is required or what bandwidths are available.

In a fourth step 408, the specific data processing system, or its representative, determines one or more bottlenecks in the end-to-end path between the specific data processing system and the content server. The one or more bottlenecks are formed by one or more specific data links in the data network, at which current bandwidth consumption is too high to allow for the video file being streamed at the bandwidth available or at the bandwidth desired by, or on behalf of, the specific data processing system. As discussed above, known tools are available to the specific data processing system, its representative, the content server, and/or another network node on the end-to-end path, to determine the bandwidth per data link, i.e., hop-by-hop.

In a fifth step 410, the specific data processing system, or its representative, having received or otherwise determined the identity of the bottlenecks, determines the identities of the one or more other data processing systems of the community that are currently consuming bandwidth at the one or more bottleneck data links. For example, the specific data processing system, or its representative broadcast a message to the community with a request to respond if the receiving data processing system is currently consuming bandwidth at one or more of the bottleneck data links. As another example, all data processing systems of the community keep one another informed about the data links on which they are currently consuming bandwidth.

In a sixth step 412, the specific data processing system, or its representative, starts negotiations with the other data processing systems, which are currently consuming bandwidth on the one or more bottleneck data links, about giving up some bandwidth. As discussed earlier, giving up some bandwidth is in principle feasible if the current consumption of bandwidth relates to receiving or transmitting electronic content information that is available in a multi-bitrate encoding scheme.

In a seventh step 414, the specific data processing system or its representative, keep track of the behavior of the other data processing systems during the negotiation. As discussed above, behavior of a particular data processing system during the current negotiation and/or past negotiations may play a role in determining how to respond to a future request of the particular data processing system for relinquishing bandwidth.

In an eight step 416, the specific data processing system or its representative determine if the negotiation has been successful. That is, it is determined if one or more of the other data processing systems have decided to give up some bandwidth so as to enable the specific data processing system to receive the requested video file in a streaming session.

If the negotiation was successful, the first method 400 proceeds with a ninth step 418 wherein the streaming session is started and the first method 400 ends in a tenth step 420.

If the negotiation was not successful, i.e., the other data processing systems were not willing to give up enough bandwidth for the streaming session, or the negotiations had not completed before a pre-determined time period expired, the first method 400 terminates the negotiations, and the requested session is canceled. Optionally, the first method 400 proceeds with an eleventh step 422, wherein the specific data processing system or its representative waits for a time period of pre-determined or random length before returning to e.g., the second step 404 or to the fourth step 408. The returning to the second step 404 or the fourth step 408 after some time has elapsed may be worth the effort as the bandwidth conditions on the data network may have changed owing to, e.g., certain other data processing systems having terminated their sessions.

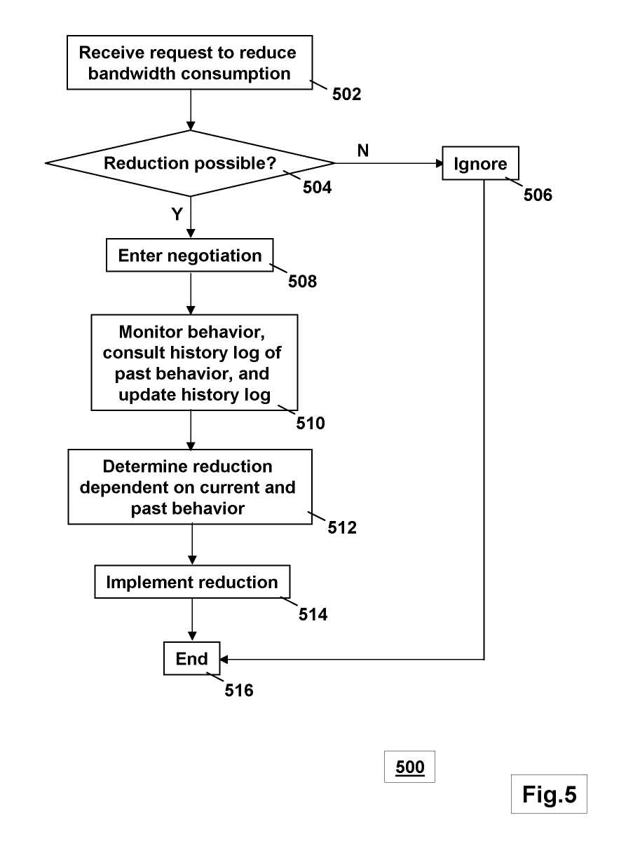

FIG. 5 is a diagram of a second method 500 of managing bandwidth consumption in a community of data processing systems on a data network. The first method 400 described above illustrated the actions of a first data processing system that intended to start a first data communication session via the data network. The second method 500 illustrates the actions of a second data processing system, or its representative to the community, that is currently consuming bandwidth in an ongoing second data communication session on the data network.

In a first step 502, the second data processing system is consuming bandwidth on the data network in a current, second data communication session. During the second data communication session, the second data processing system, or its representative, receives a request to enter negotiations with a first data processing system about reducing bandwidth consumption.

In a second step 504, the second data processing system, or its representative, verifies if a reduction in bandwidth consumption is possible, in principle. A reduction is in principle possible, for example, if the second data communication session is not time-critical to the second data processing system, or if the second data communication session relates to receiving or transmitting electronic content information that is available in a multi-bitrate encoding scheme. If the second data communication session is not time-critical, it can be aborted and restarted later on. If the second data communication session relates to the communication of electronic content information that is available in a multi-bitrate encoding scheme, and if the electronic content information is currently communicated at a higher one of the available bitrates, it could be decided in principle to change to a lower one of the available bitrates. A reduction is not feasible if it is undesirable to abort the second data communication session, or if the current bitrate of the second data communication session cannot be reduced.

If it is determined in the second step 504 that a reduction is not possible, the second method 500 proceeds to a third step 506, wherein it is decided to ignore the request received in the first step 502 and to forfeit participating in the negotiation, whereupon the second method 500 ends.

If it is determined in the second step 504 that a reduction is possible, in principle, the second method 500 proceeds to a fourth step 508.

In the fourth step 508, the second data processing system or its representative, enters negotiations with the first data processing system and, optionally, with further data processing systems of the community that have also been requested by the first data processing system, or by its representative, to participate in the negotiations.

In a fifth step 510, the second data processing system or its representative monitors the behavior of the first data processing system and, optionally, of the further data processing systems participating in the negotiations. In the fifth step 510, the second data processing system or its representative, also consults a history log with information, gathered from past negotiations and relating to past behavior of the participants to the current negotiation.

In a sixth step 512, the second data processing system or its representative uses this information to determine a reduction under control of a previous reduction, offered by the specific data processing system in a previous bandwidth consumption, as a result of a previous negotiation.

Optionally, the reduction is also determined under control of further previous reductions offered on previous occasions by one of more of the further data processing systems currently participating in the negotiation.

Optionally, the reduction is also determined in dependence on an attribute of the specific data communication session, requested by the first data processing system, the attribute being different from the bandwidth required. For example, if the requested data communication session relates to a live broadcast or to a high-priority data communication session, and the ongoing data communication session of the second data processing system is low-priority or is not time critical, the second data processing system may be inclined to give up bandwidth more easily.

Once the reduction has been determined in the sixth step 512, the second method 500 proceeds with a seventh step 514, wherein the reduction is implemented. For example, the second data communication session of the second data processing system is terminated or is continued at a lower bitrate. After the seventh step 514, the second method 500 ends in an eighth step 516.

1. A method of managing bandwidth consumption of a community of data processing systems connected to a data network, wherein the data network comprises a plurality of nodes interconnected through data links, the method comprising:
determining an additional amount of bandwidth required for a specific data communication session of a specific one of the data processing systems with a resource on the data network before the specific data communication session is initiated;
determining if the additional amount of bandwidth causes a conflict with current bandwidth consumption on at least a specific one of data links; and
if the additional amount of bandwidth causes the conflict with the current bandwidth consumption:
identifying one or more other ones of the data processing systems currently involved in the bandwidth consumption on the specific data link; and
initiating resolving the conflict by means of negotiating with the one or more other data processing systems a respective reduction in a respective other amount of bandwidth currently consumed by a respective one of the other data processing systems.

2. The method of claim 1, wherein the specific data communication session is prevented from being initiated if the negotiating is not completed within a pre-determined time period.

3. A method of managing bandwidth consumption of a community of data processing systems connected to a data network, wherein the data network comprises a plurality of nodes interconnected through data links, the method comprising:
receiving a request to participate in a negotiation with a specific data processing system about a reduction in an amount of bandwidth currently consumed on a specific one of the data links; and
determining a magnitude of the reduction under control of a previous reduction in bandwidth consumption, offered by the specific data processing system in a previous negotiation.

4. The method of claim 3, wherein the magnitude is determined under control of an attribute of the specific data communication session other than the bandwidth required.

5. The method of claim 3, wherein the magnitude is determined under control of an identity of a further one of the data processing systems participating in the negotiation.

6. A non-transitory computer readable medium having instructions stored thereon that, in response to execution by a processor, cause the processor to perform operations, wherein the instructions are for managing bandwidth consumption of a community of data processing systems connected to a data network, wherein the data network comprises a plurality of nodes interconnected through data links, the instructions comprising:
instructions for determining an additional amount of bandwidth required for a specific data communication session of a specific one of the data processing systems with a resource on the data network before the specific data communication session is initiated;
instructions for determining if the additional amount of bandwidth causes a conflict with current bandwidth consumption on at least a specific one of data links; and
instructions for, if the additional amount of bandwidth causes conflict with the current bandwidth consumption:
identifying one or more other ones of the data processing systems currently involved in the bandwidth consumption on the specific data link; and
initiating resolving the conflict by means of negotiating with the one or more other data processing systems a respective reduction in a respective other amount of bandwidth currently consumed by a respective one of the other data processing systems.

7. The non-transitory computer readable medium of claim 6, wherein the instructions further comprise instructions for preventing the specific data communication session from being initiated if the negotiating is not completed within a predetermined time period.

8. A non-transitory computer readable medium having instructions stored thereon that, in response to execution by a processor, cause the processor to perform operations, wherein the instructions are for managing bandwidth consumption of a community of data processing systems connected to a data network, wherein the data network comprises a plurality of nodes, the instructions comprising:
instructions for receiving a request to participate in a negotiation with a specific data processing system about a reduction in an amount of bandwidth currently consumed on a specific one of the data links; and
instructions for determining a magnitude of the reduction under control of a previous reduction in bandwidth consumption, offered by the specific data processing system in a previous negotiation.

9. The non-transitory computer readable medium of claim 8, wherein the instructions further comprise instructions for determining the magnitude under control of an attribute of the specific data communication session other than the bandwidth required.

10. The non-transitory computer readable medium of claim 8, wherein the instructions further comprise instructions for determining the magnitude under control of an identity of a further one of the data processing systems participating in the negotiation.

11. A first data processing system, comprising:
a network interface for data communication via a data network that comprises a plurality of nodes interconnected through data links, wherein the first data processing system is configured to:
determine an additional amount of bandwidth required for a specific data communication session of the first data processing system via the data network before the specific data communication session is initiated;
determine if the additional amount of bandwidth causes a conflict with current bandwidth consumption on at least a specific one of data links; and
if the additional amount of bandwidth causes the conflict with the current bandwidth consumption:
identify one or more other data processing systems currently involved in the bandwidth consumption on the specific data link; and
initiate resolving the conflict by means of negotiating with the one or more other data processing systems a respective reduction in a respective other amount of bandwidth currently consumed by a respective one of the other data processing systems.

12. A data processing system comprising:
a network interface for data communication via a data network that comprises a plurality of nodes interconnected through data links, wherein the second data processing system is configured to:
receive a request to participate in a negotiation with a specific other data processing system about a reduction in an amount of bandwidth currently consumed on a specific one of the data links; and
determine a magnitude of the reduction under control of a previous reduction of bandwidth consumption, offered by the specific data processing system in a previous negotiation.
